(19) United States
(12) Patent Application Publication
(10) Pub. No.: US 2005/0002313 A1
(43) Pub. Date: Jan. 6, 2005

(54) Optical head device, diffraction element and manufacturing method for diffraction element

(76) Inventor: Kenichi Hayashi, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/822,086

(22) Filed: Apr. 9, 2004

(30) Foreign Application Priority Data
Apr. 11, 2003 (JP) 2003-108204
Nov. 25, 2003 (JP) 2003-394179

(51) Int. Cl. G11B 7/00; G11B 7/135

(52) U.S. Cl. 369/112.03; 369/112.05; 369/112.07

(57) ABSTRACT

An optical head device includes a first light source which emits a first laser beam, a second light source which emits a second laser beam, a common optical path for guiding the first laser beam or the second laser beam to an optical recording medium, and a diffraction element disposed on the common optical path. The diffraction element includes a partially formed first diffraction grating such that the first laser beam is diffracted and the second laser beam is transmitted without being diffracted and a partially formed second diffraction grating such that the second laser beam is diffracted and the first laser beam is transmitted. The partially formed first diffraction grating and the partially formed second diffraction grating are formed in a side by side relation.

### CROSS-REFERENCE TO RELATED APPLICATIONS

This application claims priority to Japanese Application No. 2003-108204 filed Apr. 11, 2003 and priority to Japanese Application No. 2003-394179 filed Nov. 25, 2003, which are incorporated herein by reference.

### BACKGROUND OF THE INVENTION

1. Field of the Invention

The present invention relates to an optical head device which is used for reproducing from and/or recording to an optical recording medium such as a DVD or a CD, and a diffraction element for the optical head device and a manufacturing method for the diffraction element.

2. Description of the Related Art

A two-wavelength optical head device has been known as an optical head device, which is provided with a laser diode for emitting a laser beam with a wavelength of 650 nm band for reproducing from and recording in a DVD-R and a laser diode for emitting a laser beam with a wavelength of 780 nm band for reproducing from and recording in a CD-R.

For example, as shown in FIG. 9, a two-wavelength optical head device 100 includes a first laser light source 101 emitting a first laser beam L1 with a wavelength of 650 nm band for reproducing from and recording in a DVD-R, a second laser light source 102 emitting a second laser beam L2 with a wavelength of 780 nm band for reproducing from and recording in a CD-R, and a common optical system 104 which guides the first laser beam L1 and the second laser beam L2 to an optical recording medium 103.

The common optical system 104 includes a first beam splitter 141 which reflects the first laser beam L1 to the optical recording medium 103, a second beam splitter 142 which transmits the first laser beam L1 reflected by the first beam splitter 141 and reflects the second laser beam L2 to the optical recording medium 103, a collimating lens 143 for converting the first laser beam L1 and the second laser beam L2 from the second beam splitter 142 into parallel light, and an objective lens 144 for condensing the parallel light from the collimating lens 143 to the optical recording medium 103. The common optical system 104 also includes a sensor lens 145 for condensing the return light of the first laser beam L1 or the second laser beam L2 reflected by the optical recording medium 103 and transmitting through the second beam splitter 142 and the first beam splitter 141, and a common light receiving element 146 which receives the return light of the first laser beam L1 or the second laser beam L2 which passes through the sensor lens 145.

A first diffraction element 105 is disposed between the first laser light source 101 and the common optical system 104, and a second diffraction element 106 is disposed between the second laser light source 102 and the common optical system 104. The diffracted lights of the first laser beam L1 generated by the first diffraction element 105 and the diffracted lights of the second laser beam L2 generated by the second diffraction element 106 are used to detect a tracking error by the differential push-pull method (DPP method) or the like.

The step heights of the diffraction gratings in the first and the second diffraction elements 105 and 106 are respectively set to be correspond to the wavelengths of the first and the second laser beams L1 and L2. For example, when the optical head device 100 is produced exclusively for reproduction, the step heights in the first and the second diffraction elements 105 and 106 are set to be in the range from about 0.1 μm to 0.5 μm. Alternatively, when the optical head device 100 is produced to be capable of reproducing and recording, the demultiplexing ratio of the first-order diffracted light/zero-order light is set to make smaller and the ratio of the zero-order light is increased from the standpoint of the energy efficiency. Therefore, the step heights are required to be set in the range of about 0.1-0.2 μm.

However, the optical head device 100 provided with the first and the second diffraction elements 105 and 106 described above has the following problems.

Since two diffraction elements, i.e., the first and the second diffraction elements 105 and 106 are used, the number of parts increases. Further, the positions of the first and the second diffraction elements 105 and 106 are respectively required to be adjusted and thus much labor is necessary to assemble the optical head device.

As described above, in a reproduction-only optical head device 100, the step heights of the first and the second diffraction elements 105 and 100 are set to be in the range from about 0.1 82 m to 0.5 μm and thus a high degree of freedom of design is obtained. However, when the optical head device 100 is capable of reproducing and recording, the step heights are restricted only in the range of about 0.1-0.2 μm.

The first and the second diffraction elements 105 and 106 are disposed in the vicinity of the first and second laser light sources 101 and 102 and thus the respective pitches of the diffraction gratings are required to be narrower. Accordingly, when the diffraction grating is formed by semiconductor process such as film forming technique and photo lithography technique, an expensive exposure equipment such as a stepper is required. Alternatively, when the diffraction grating is formed by cutting work, a cutting tool with a narrow width is required. Therefore, both the methods are not suitable for mass-production.

In addition, when the laser light source of a twin laser type in which the first and the second laser light sources 101 and 102 are mounted in one package is used, the first and the second diffraction elements 105 and 106 are required to be arranged in parallel in the direction of the optical axis of the optical head device. Therefore, either of the laser beams generates much unwanted light when passing through the diffraction element corresponding to the other laser beam, which causes noise and the reduction of efficiency.

### SUMMARY OF THE INVENTION

In view of the problems described above, it is a primary object of the present invention to provide an optical head device provided with a diffraction element which is capable of forming a first diffraction grating and a second diffraction grating even in mass production with a high degree of accuracy, and to provide the diffraction element and a manufacturing method for the diffraction element.

In order to achieve the above object, according to the present invention, there is provided an optical head device including a first light source which emits a first laser beam, a second light source which emits a second laser beam with a wavelength different from that of the first laser beam, a common optical path for guiding the first laser beam and the second laser beam emitted from the light sources to an optical recording medium and a diffraction element disposed on the common optical path. The diffraction element includes a first diffraction grating formed in a partial area on an incident face or an emitting face of the diffraction element such that the first laser beam is diffracted and the second laser beam is transmitted without being diffracted, and a second diffraction grating formed in a partial area on the incident face or the emitting face of the diffraction element such that the second laser beam is diffracted and the first laser beam is transmitted.

In accordance with an embodiment of the present invention, the diffraction element is formed of a translucent substrate on which a first diffraction grating formed area where the first diffraction grating is formed and a second diffraction grating formed area where the second diffraction grating is formed are dividedly provided on a same side of the translucent substrate. According to the construction described above, the first diffraction grating and the second diffraction grating are respectively formed in a limited area on the same side of the translucent substrate, and thus the first diffraction grating and the second diffraction grating are partially formed on the emitting face or the incident face of the diffraction element. Also, since the first diffraction grating and the second diffraction grating are formed on the same side of the diffraction element, the directions of the diffraction gratings can be aligned with a high degree of precision.

In accordance with an embodiment of the present invention, the diffraction element is formed of a translucent substrate having a first face which is divided into a first diffraction grating formed area where the first diffraction grating is formed and a transmitting area where the first laser beam is not diffracted. The translucent substrate also has a second face which is divided into a second diffraction grating formed area where the second diffraction grating is formed and a transmitting area where the second laser beam is not diffracted, and the second face is disposed to opposite to the first face.

According to the construction described above, the first diffraction grating and the second diffraction grating are partially formed on either of the emitting face or the incident face of the diffraction element. Further, the configuration accuracies of the diffraction gratings on both sides of the diffraction element can be improved in comparison with the case that the diffraction gratings are formed on the entire surfaces of the incident face and the emitting face of the diffraction grating.

In accordance with an embodiment of the present invention, it is preferable that the first diffraction grating and the second diffraction grating are respectively formed with a plurality of steps having a predetermined height. The step heights of the first diffraction grating and the second diffraction grating are set separately and thus the diffraction efficiencies of the first diffraction grating and the second diffraction grating are capable of setting in a suitable manner.

In accordance with an embodiment of the present invention, it is preferable that the step height of the first diffraction grating is set to satisfy the formula “aλ2/(n−1)” and the step height of the second diffraction grating is set to satisfy the formula “bλ1/(n−1)” wherein “λ1” is the wavelength of the first laser beam, “λ2” is the wavelength of the second laser beam, “n” is the refractive index of the translucent substrate, and “a” and “b” are respectively an integer number not less than “1”. According to the setting for the step heights described above, desired diffraction efficiencies can be obtained by selecting the values of the integer numbers “a” and “b”.

In accordance with an embodiment of the present invention, it is preferable that the optical component of the first laser beam diffracted by the first diffraction grating is set to be in phase with the optical component of the first laser beam transmitting through the second diffraction grating. According to the construction described above, the transmission factor of the first laser beam becomes high and the spot diameter of the first laser beam can be made smaller.

In accordance with an embodiment of the present invention, the same side face of the translucent substrate is divided into the first diffraction grating formed area and the second diffraction grating formed area. In this case, the same side face of the translucent substrate is preferably, for example, divided in a stripe shape. According to this construction, the first diffraction grating formed area and the second diffraction grating formed area are arranged simply side by side, and thus the diffraction element is easy to be produced and diffracted light caused by dividing into two areas does not generate. Concretely, when the first diffraction grating formed area and the second diffraction grating formed area are formed to be divided in a stripe shape, the width of each area is preferably set to be about 100 times or more of the wavelength of the using laser beam. According to the construction described above, the generation of the diffracted light caused by dividing into two areas is suppressed and satisfactory recording and reproducing are performed.

In accordance with an embodiment of the present invention, it is preferable that the same side face of the translucent substrate is divided into the first diffraction grating formed area and the second diffraction grating formed area in a concentrically circular shape. According to the construction described above, a reproducing signal and a recording signal together with a tracking error detection signal can be satisfactorily obtained.

In accordance with an embodiment of the present invention, it is preferable that the same side face of the translucent substrate is divided into a plurality of concentrically circular areas of the first diffraction grating formed area and the second diffraction grating formed area which are positioned alternately. According to the construction described above, the beam configuration can be formed to be nearly equal to that of the incident light for both the zero-order beam and the diffracted lights and thus satisfactory recording and reproducing are performed.

In accordance with an embodiment of the present invention, it is preferable that the same side face of the translucent substrate is divided into the first diffraction grating formed area and the second diffraction grating formed area in a matrix shape. According to the construction described above, the beam configuration can be formed to be nearly equal to that of the incident light for both the zero-order beam and the diffracted lights and thus satisfactory recording and reproducing are performed.

In accordance with an embodiment of the present invention, a first face of the translucent substrate is provided with the first diffraction grating formed area and a second face of the translucent substrate is provided with the second diffraction grating formed area. In this case, it is preferable that the first face and the second face are respectively formed with the first diffraction grating formed area and the second diffraction grating formed area in a concentrically circular shape. According to the construction described above, the beam configurations of the first laser beam and the second laser beam can be formed to be nearly equal to that of the incident light and thus satisfactory recording and reproducing are performed.

In this case, it is preferable that the first diffraction grating formed area and the second diffraction grating formed area are respectively formed wider than the effective diameter of the laser beams passing through the respective areas. According to the construction described above, in the case of the adjustment when the diffraction element is mounted on the optical head device, the range of positional adjustment for the diffraction element is widened with respect to the positional adjustment along the optical axis direction, the direction orthogonal to the optical axis, and the rotational adjustment in which the diffraction element is rotated around the optical axis to adjust the direction of the diffraction grating. Therefore, the rotational adjustment of the diffraction element is easily performed.

In accordance with an embodiment of the present invention, the wavelength of the first laser beam is shorter than the wavelength of the second laser beam. In this case, the diffraction element is preferably provided with an area which does not diffract the first laser beam in a central area including the optical axis. According to the construction described above, the first laser beam is not diffracted in the central area. Therefore, when information is recorded in an optical recording medium by the first laser beam, the beam spot with a high efficiency in the central part is used. In this case, when the diffraction grating for the first laser beam is formed in the outer peripheral side of the central area, desired diffracted lights can be obtained.

In accordance with an embodiment of the present invention, the diffraction element is preferably disposed at a position of the common optical path where only the first and the second laser beams toward the optical recording medium pass through and the return beams of the first and the second laser beams reflected by the optical recording medium do not pass through. According to the construction described above, the diffraction element does not diffract the return beam reflected by the optical recording medium and thus the generation of a noise caused by the diffraction of the return beam can be prevented.

Further, in order to achieve the above object, according to the present invention, there is provided a diffraction element in which a first laser beam and a second laser beam with a wavelength different from that of the first laser beam are capable of being incident. The diffraction element is comprised of a translucent substrate. At least the same side face of the translucent substrate is divided into a first diffraction grating formed area where the first diffraction grating which diffracts the first laser beam and transmits the second laser beam without diffracting is formed and a second diffraction grating formed area where the second diffraction grating which diffracts the second laser beam and transmits the first laser beam without diffracting is formed.

Furthermore, in order to achieve the above object, according to the present invention, there is provided a manufacturing method for the above-mentioned diffraction element including providing a molding die for molding the diffraction element, forming the molding die first grooves constituting the first diffraction grating and second grooves constituting the second diffraction grating by cutting work, then, molding the diffraction element by using the molding die.

As described above, the diffraction element in accordance with the present invention is capable of disposing in a common optical path and thus the diffraction element can be positioned away from the first and the second laser light sources. Therefore, the pitch of the grating in the first and the second diffraction gratings can be widened and thus a cutting tool of which the width of the cutting part is comparatively wider can be used for cutting work to form the grooves on the molding die. Also, since the first and the second diffraction gratings are formed on the same side face, even at the time of assembling the molding die, the directions of the diffraction gratings are not required to be aligned with a high degree of accuracy in comparison with the case that the diffraction gratings are respectively formed on both sides of the diffraction element. In addition, since the step heights of the first diffraction grating and the second diffraction grating are different from each other, cutting work is easier than semiconductor process to form the grooves for the diffraction grating and the cost of equipment is lower.

In accordance with an embodiment of the present invention, it is preferable that the first groove and the second groove are formed on a fixed side mold member constituting the molding die. When the diffraction element is molded with the molding die having the construction described above, the diffraction element with a high degree of dimensional accuracy of the grooves can be obtained in comparison with the case that the first groove and the second groove are formed on a movable side mold member of the molding die.

In another manufacturing method for a diffraction element according to the present invention, the first groove for the first diffraction grating and the second groove for the second diffraction grating are directly formed on a translucent substrate constituting the diffraction element by cutting work with a cutting tool.

As described above, the diffraction element in accordance with the present invention is capable of disposing in the common optical path and thus the diffraction element can be positioned away from the first and the second laser light sources. Accordingly, since the pitch of the grating in the first and the second diffraction gratings can be widened, the grooves for the grating can be formed on the substrate by cutting work by using a cutting tool having a wide cutting edge. Further, since the step heights of the first diffraction grating and the second diffraction grating are different from each other, cutting work is easier than semiconductor process to form the grooves for the diffraction grating and the cost of equipment is lower.

In accordance with an embodiment of the present invention, the diffraction element is formed by a translucent substrate having a first face which is divided into a first diffraction grating formed area where the first diffraction grating is formed, which diffracts the first laser beam and transmits the second laser beam without diffracting, and a transmitting area where the first laser beam is not diffracted. The translucent substrate also has a second face which is divided into a second diffraction grating formed area where the second diffraction grating is formed, which diffracts the second laser beam and transmits the first laser beam without diffracting, and a transmitting area where the second laser beam is not diffracted, and the second face and the first face are opposite to each other.

In a manufacturing method for a diffraction element according to an embodiment of the present invention, first grooves for the first diffraction grating are formed on a molding die and then second grooves for the second diffraction grating are formed on the molding die by cutting work with a cutting tool. After then, the diffraction element is molded by using the molding die.

As described above, the diffraction element is capable of disposing in the common optical path and thus the diffraction element can be positioned away from the first and the second laser light sources. Accordingly, since the pitch of the grating can be widened, the grooves for the grating can be formed on the molding die by cutting work by using a cutting tool having a wide cutting edge. Further, the first and the second diffraction gratings are partially formed on both sides of the diffraction element and thus the configuration accuracies of the diffraction gratings can be improved in comparison with the case that the diffraction gratings are formed on the entire surfaces of the diffraction grating. Also, even at the time of assembling the molding die, the directions of the diffraction gratings are capable of being aligned with each other with a high degree of precision in comparison with the case that the diffraction gratings are formed on the entire surfaces of the diffraction grating.

In another manufacturing method for a diffraction element according to an embodiment of the present invention, first grooves for the first diffraction grating are formed on a translucent substrate and then second grooves for the second diffraction grating are formed on the translucent substrate by cutting work with a cutting tool.

In accordance with an embodiment of the present invention, a diffraction element in which a first laser beam, a second laser beam and a third laser beam respectively having different wavelengths from one another are capable of being incident is constituted of a translucent substrate. One face of the translucent substrate is divided into at least a first diffraction grating formed area where the first diffraction grating which diffracts the first laser beam with a predetermined diffraction efficiency is formed and an area which does not diffract the second laser beam and the third laser beam. The other face of the translucent substrate opposite to the one face of the translucent substrate is divided into a second diffraction grating formed area where the second diffraction grating which diffracts the second laser beam with a predetermined diffraction efficiency and transmits the third laser beam without diffracting is formed, a third diffraction grating formed area where the third diffraction grating which diffracts the third laser beam with a predetermined diffraction efficiency and transmits the second laser beam without diffracting is formed, and an area which does not diffract the first laser beam.

In the diffraction element used in the optical head device according to the present invention, the first diffraction grating is formed in a partial area on an incident face or an emitting face of the diffraction element such that the first laser beam is diffracted and the second laser beam is transmitted without being diffracted, and a second diffraction grating is formed in a partial area on the incident face or the emitting face of the diffraction element such that the second laser beam is diffracted and the first laser beam is transmitted. According to the diffraction element, only one diffraction element can provide the zero-order light and the diffracted lights of each of the first laser beam and the second laser beam to generate the reproducing signal, recording signal and tracking error detection signal for two types of optical recording media.

Also, in a conventional diffraction grating, the demultiplexing ratio of the zero-order light and the first-order diffracted lights is adjusted only from the step height and the duty ratio of the diffraction grating. However, in the diffraction element according to the present invention, the demultiplexing ratio of the zero-order light and the first order diffracted lights is capable of being easily adjusted by adjusting the areas of the first diffraction grating formed area and the second diffraction grating formed area. Therefore, the degree of freedom of a design is remarkably widened and thus the optimal diffraction element with a high degree of efficiency is obtained with respect to the first and the second laser beams. In addition, the diffraction element according to the present invention can be applied to a twin laser in which the first and the second laser light sources are mounted within one package.

Moreover, according to the present invention, the diffraction element can be disposed on the common optical path and thus capable of being positioned away from the first and the second laser light sources. Therefore, the pitch of the diffraction grating in the first and the second diffraction gratings can be widened. Accordingly, the first and the second diffraction gratings can be easily formed in mass production. Further, according to the diffraction element in which the first and the second diffraction gratings are formed on the same side face of the diffraction element, the diffraction element is suitable for mass production even by using a molding die or by semiconductor process in comparison with the conventional diffraction element in which the first and the second diffraction gratings are formed on the entire surface of both sides of the diffraction element.

In other words, when the diffraction element is produced by a molding die, the first and the second diffraction gratings can be formed by the fixed side molding die having an excellent transferring property and thus the diffraction element can be formed with a high degree of accuracy. Further, even at the time of assembling the molding die, the directions of the diffraction gratings are not required to adjust with a high degree of accuracy as the case of the conventional diffraction element. Alternatively, when the diffraction element is produced by semiconductor process, the first and the second diffraction gratings are formed on the same side face of the substrate and thus an excellent productivity is obtained in comparison with the case that the diffraction gratings are formed on both sides of the diffraction element.

According to the present invention, when the first and the second diffraction gratings are formed on both sides of the diffraction element, the first and the second diffraction gratings are respectively formed in a partial area. Therefore, the diffraction element is suitable for mass production even by using a molding die in comparison with the conventional diffraction element in which the first and the second diffraction gratings are formed on the entire surface of both sides of the diffraction element. In other words, when the diffraction element is formed by the molding die, the first and the second diffraction gratings are respectively formed on both sides in the partial area by the molding die. Therefore, the diffraction grating formed by the movable side molding die having poor transferring property is formed more accurate than that formed on the entire face of the diffraction element. Further, even at the time of assembling the molding die, the directions of the diffraction gratings can be adjusted with a high degree of accuracy in comparison with the case that the diffraction gratings are formed on the entire surfaces of the diffraction element.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a schematic constructional al view which shows an optical system of an optical head device in accordance with a first embodiment of the present invention;

FIG. 2(A) is a plan view of a diffraction element in accordance with the first embodiment of the present invention. FIG. 2(B) is its right side view, FIG. 2(C) is a transverse cross-sectional view schematically showing the diffraction grating of the diffraction element shown in FIG. 2(A), FIG. 2(D) is an explanatory view showing diffracting state of the first laser beam by the diffraction element, and FIG. 2(E) is an explanatory view showing diffracting state of the second laser beam by the diffraction element;

FIG. 3(A) is a plan view of a diffraction element in accordance with a third embodiment of the present invention and FIG. 3(B) is a side view of the diffraction element shown in FIG. 3(A);

FIG. 4(A) is a plan view of a diffraction element in accordance with a fourth embodiment of the present invention and FIG. 4(B) is a side view of the diffraction element shown in FIG. 4(A);

FIG. 5(A) is a plan view of a diffraction element in accordance with a fifth embodiment of the present invention and FIG. 5(B) is a side view of the diffraction element shown in FIG. 5(A);

FIG. 6(A) is a plan view of a diffraction element in accordance with a seventh embodiment of the present invention. FIG. 6(B) is its side view, FIG. 6(C) is its rear face view, FIG. 6(D) is an explanatory view showing diffracting state of the first laser beam by the diffraction element, and FIG. 6(E) is an explanatory view showing diffracting state of the second laser beam by the diffraction element;

FIG. 7 is an explanatory view showing another disposing position of a diffraction element in an optical head device accordance with an embodiment of the present invention;

FIG. 8 is an explanatory view showing a disposing position of a diffraction element in an optical head device provided with a twin laser which emits a first laser beam and a second laser beam; and

FIG. 9 is a schematic constructional al view which shows the optical system of a conventional optical head device.

### DETAILED DESCRIPTION OF THE PREFERRED EMBODIMENTS

Optical head devices in accordance with embodiments of the present invention will be described below with reference to the accompanying drawings.

Embodiment 1

Overall Construction

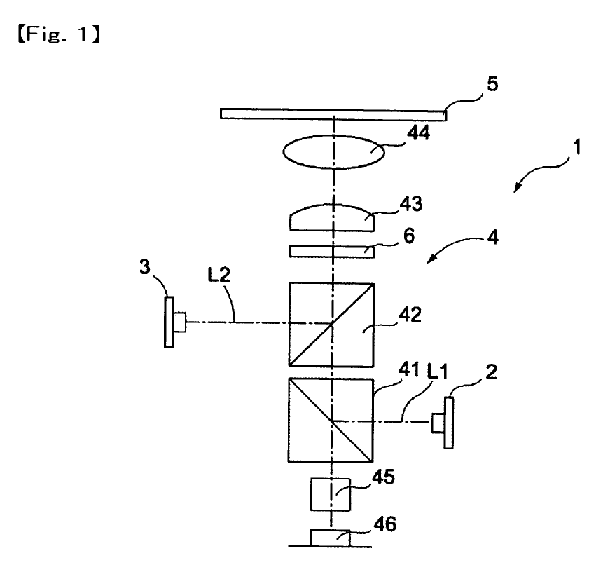

FIG. 1 is a schematic constructional view which shows an optical system of an optical head device in accordance with a first embodiment of the present invention. The optical head device 1 in the first embodiment of the present invention is capable of reproducing and/or recording information to a plural types of optical recording media 5 such as a DVD-R and a CD-R, which are different in the substrate thickness and recording density. The optical head device 1 includes a first laser diode 2 emitting a first laser beam L1 with a wavelength of 650 nm band, a second laser diode 3 emitting a second laser beam L2 with a wavelength of 780 nm band, and a common optical system 4.

The common optical system 4 includes a first beam splitter 41 which reflects the first laser beam L1 to an optical recording medium 5, a second beam splitter 42 which transmits the first laser beam L1 reflected by the first beam splitter 41 and reflects the second laser beam L2 to the optical recording medium 5, a collimating lens 43 for converting the first laser beam L1 and the second laser beam L2 from the second beam splitter 42 into parallel light, and an objective lens 44 for condensing the parallel light from the collimating lens 43 to the optical recording medium 5.

The common optical system 4 also includes a sensor lens 45 for condensing the return light of the first or the second laser beam which is reflected by the optical recording medium 5 and transmits through the second beam splitter 42 and the first beam splitter 41, and a light receiving element 46 which receives the return light of the first laser beam L1 or the second laser beam L2 which passes through the sensor lens 45.

In addition, in the embodiment of the present invention, the common optical system 4 is provided between the second beam splitter 42 and the collimating lens 43 with a diffraction element 6 which emits zero-order light and ±first-order diffracted lights of the first laser beam L1 or the second laser beam L2.

The detailed construction of the diffraction element 6 will be described below. In the optical head device 1, when information is reproduced from or recorded into a DVD-R as an optical recording medium 5, the first laser beam L1 with the wavelength of 650 nm is emitted from the first laser light source 2. The first laser beam L1 is guided by the common optical system 4 and converged into a light spot by the objective lens 44 on the recording surface of the DVD-R. The return light of the first laser beam L1 reflected by the recording surface of the DVD-R is condensed on the light receiving element 46. The reproducing and recording of the information of the DVD-R are performed by the signals detected with the light receiving element 46.

The reproducing and recording of the information of the DVD-R are performed by using the zero-order light emitted from the diffraction element 6. The ±first-order diffracted lights emitted from the diffraction element 6 are used to detect a tracking error by the differential push-pull method (DPP method).

On the contrary, when information is reproduced from or recorded into a CD-R as the optical recording medium 5, the second laser beam L2 with the wavelength of 780 nm is emitted from the second laser light source 3. The second laser beam L2 is guided by the common optical system 4 and converged into a light spot by the objective lens 44 on the recording surface of the CD-R. The return light of the second laser beam L2 reflected by the recording surface of the CD-R is condensed on the light receiving element 46. The reproducing and recording of the information of the CD-R are performed by signals detected with the light receiving element 46.

The reproducing and recording of the information of the CD-R are performed by using the zero-order light emitted from the diffraction element 6. The ±first-order diffracted lights emitted from the diffraction element 6 are used to detect a tracking error by the differential push-pull method (DPP method).

Construction of Diffraction Element

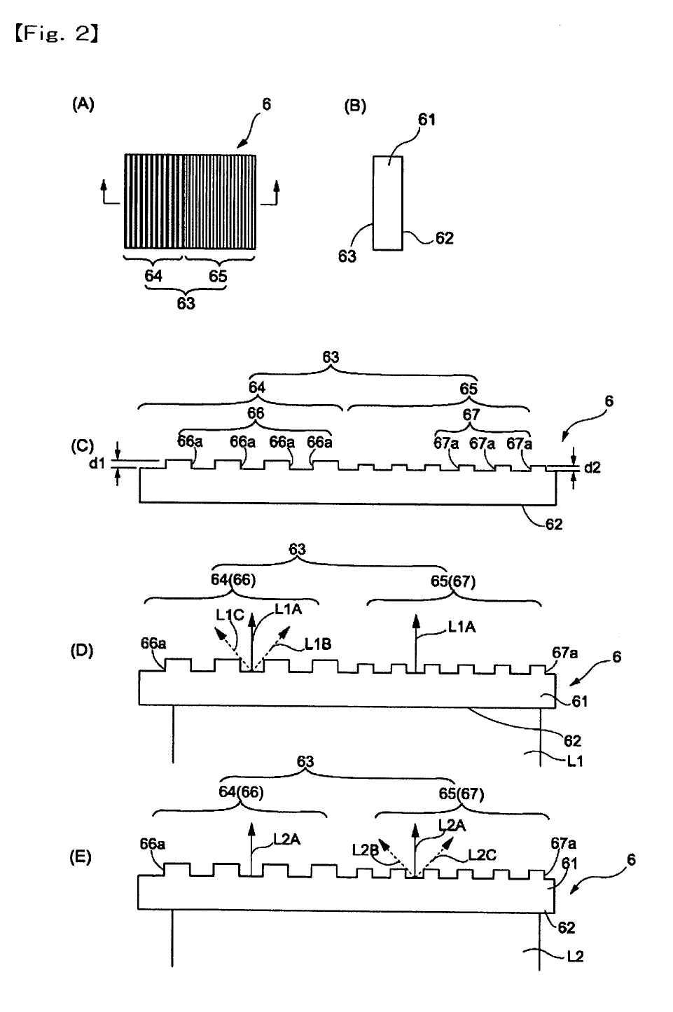

FIG. 2(A) is a plan view of the diffraction element in accordance with the first embodiment of the present invention, FIG. 2(B) is its right side view, and FIG. 2(C) is a transverse cross-sectional view schematically showing the diffraction grating of the diffraction element shown in FIG. 2(A). FIG. 2(D) is an explanatory view showing diffracting state of the first laser beam L1 by the diffraction element 6 and FIG. 2(E) is an explanatory view showing diffracting state of the second laser beam L2 by the diffraction element 6.

As shown in these drawings, the diffraction element 6 is formed of a rectangular translucent substrate 61 which is made of a translucent material. The translucent substrate 61 is provided with an incident face 62 for the first laser beam L1 and the second laser beam L2 on one side and an emitting face 63 on the other side. The beam diameter of the first laser beam L1 is shown in FIG. 2(D) and the beam diameter of the second laser beam L2 is shown in FIG. 2(E). Therefore, both the first laser beam L1 and the second laser beam L2 are incident on a nearly entire area of the incident face 62.

In the diffraction grating 6 in the first embodiment of the present invention, the emitting face 63 of the translucent substrate 61 is divided into two areas in a stripe shape, one of which is a first diffraction grating formed area 64 and the other is a second diffraction grating formed area 65. The respective areas 64 and 65 are formed with the diffraction gratings whose configurations are different from each other.

In the first diffraction grating formed area 64 is formed a first diffraction grating 66 which diffracts the first laser beam L1 with the wavelength of 650 nm with a predetermined first-order diffraction efficiency and transmits the second laser beam L2 with the wavelength of 780 nm without diffracting. Therefore, the first diffraction grating formed area 64 is a transmission area for the second laser beam L2 through which the second laser beam L2 transmits without diffracting. The first diffraction grating 66 is comprised of a plurality of steps (protrusions and recesses) 66a formed in a stripe shape.

The height “d1” of the step 66a is set to be a dimension which becomes an integer multiple of “2π”, which generates an optical path difference of an integer multiple of one wavelength of the second laser beam L2 when the second laser beam L2 with the wavelength of 780 nm transmits through. The step height “d1” is obtained by the following equation:
d1=aλ2/(n−1)
wherein “λ2” is the wavelength of the second laser beam L2, “n” is the refractive index of the translucent substrate 61, and “a” is an integer number not less than 1(one). The diffraction efficiency of the first laser beam L1 by the step 66a is determined by the value “a”. Since the smaller the value “a”, the higher the diffraction efficiency becomes, the value “a” is, for example, set to be 1(one).

The pitch of the respective steps 66a is set such that the first laser beam L1 is diffracted at a predetermined first-order diffraction angle.

In the second diffraction grating formed area 65 is formed a second diffraction grating 67 which diffracts the second laser beam L2 with the wavelength of 780 nm with a predetermined first-order diffraction efficiency and transmits the first laser beam L1 with the wavelength of 650 nm without diffracting. Therefore, the second diffraction grating formed area 65 is a transmission area for the first laser beam L1 through which the first laser beam L1 transmits without diffracting. The second diffraction grating 67 is comprised of a plurality of steps (protrusions and recesses) 67a formed in a stripe shape. Further, the direction of the stripe of the steps 67a of the second diffraction grating 67 is different from the direction of the stripe of the steps 66a of the first diffraction grating 66. They are respectively set to form a predetermined angle.

The height “d2” of the step 67a is set to be a dimension which becomes an integer multiple of “2π”, which generates an optical path difference of an integer multiple of one wavelength of the first laser beam L1 when the first laser beam L1 with the wavelength of 650 nm transmits through. The step height “d2” is obtained by the following equation:
d2=bλ1/(n−1)
wherein “λ1” is the wavelength of the first laser beam L1, “n” is the refractive index of the translucent substrate 61, and “b” is an integer number not less than 1(one). The diffraction efficiency of the second laser beam L2 by the step 67a is determined by the value “b”. Since the smaller the value “b”, the higher the diffraction efficiency becomes, the value “b” is, for example, set to be 1(one).

The pitch of the respective steps 67a is set such that the second laser beam L2 is diffracted at a predetermined first-order diffraction angle.

In the optical head device 1 provided with the diffraction element 6 constituted constructed as described above, when reproducing or recording for a DVD-R as the optical recording medium 5 is performed, the first laser beam L1 is incident on the incident face 62 of the diffraction element 6 as shown in FIG. 2(D). The diffraction element 6 diffracts the first laser beam L1 which passes through the first diffraction grating 66 into the zero-order light L1A and ±first-order diffracted lights L1B and L1C. The tracking error detection at the time of reproducing or recording for a DVD-R is performed by the ±first-order diffracted lights L1B and L1C. The beam portion of the first laser beam L1 which passes through the second diffraction grating 67 is entirely passed through in the state of the zero-order light L1A without diffracted. Therefore, the ratio of the zero-order light L1A can be increased with respect to the ±first-order diffracted lights L1B and L1C. The reproducing or recording for a DVD-R is performed by the zero-order light L1A passed through the second diffraction grating 67 and the zero-order light L1A emitted from the first diffraction grating 66.

On the other hand, when reproducing or recording for a CD-R as the optical recording medium 5 is performed, the second laser beam L2 is incident on the incident face 62 of the diffraction element 6 as shown in FIG. 2(E). The diffraction element 6 diffracts the second laser beam L2 which passes through the second diffraction grating 67 into the zero-order light L2A and ±first-order diffracted lights L2B and L2C. The tracking error detection at the time of reproducing or recording for the CD-R is performed by the ±first-order diffracted lights L2B and L2C. The beam portion of the second laser beam L2 which passes through the first diffraction grating 66 is entirely passed through in the state of the zero-order light L2A without diffracted. Therefore, the ratio of the zero-order light L2A can be increased with respect to the ±first-order diffracted lights L2B and L2C. The reproducing or recording for the CD-R is performed by the zero-order light L2A passed through the first diffraction grating 66 and the zero-order light L2A emitted from the second diffraction grating 67.

Effects of the First Embodiment

As described above, in the diffraction element 6 in the optical head device 1 in accordance with the first embodiment, both the first diffraction grating 66 which diffracts the first laser beam L1 and transmits the second laser beam L2, and the second diffraction grating 67 which transmits the first laser beam L1 and diffracts the second laser beam L2 are formed on the same side of the translucent substrate 61. Further the diffraction element 6 is disposed on the common light path which both the first laser beam L1 and the second laser beam L2 pass. Therefore, a reproducing signal, a recording signal and a tracking error detection signal can be generated only by using one diffraction element 6 for both a DVD-R and a CD-R.

Further, the first diffraction grating formed area 64 is the transmission area of the second laser beam L2 where the second laser beam L2 is transmitted without diffracting, i.e., the zero-order light area of the second laser beam L2. Also, the second diffraction grating formed area 65 is the transmission area of the first laser beam L1 where the first laser beam L1 is transmitted without diffracting, i.e., the zero-order light area of the first laser beam L1. Therefore, the demultiplexing ratio of the zero-order light to the first-order diffracted light for the first laser beam L1 and the second laser beam L2 can be easily adjusted by means of adjusting the area of the first diffraction grating formed area 64 and the area of the second diffraction grating formed area 65. Accordingly, the zero-order light necessary for recording can be obtained with a high degree of power. In addition, the diffraction element 6 can be used for a twin laser light source which carries both the first and the second laser light sources 2 and 3 in the same package.

Besides, the diffraction element 6 can be disposed on the common optical path away from the first and the second laser light sources 2 and 3. Therefore, the pitch of the grating in the first and the second diffraction gratings 66 and 67 can be widened. Accordingly, the first and the second diffraction gratings 66 and 67 can be formed easily in mass production.

Further, the first and the second diffraction gratings 66 and 67 are formed on the same side of the diffraction element 6. Therefore, in the case the diffraction element 6 is produced, the diffraction element 6 is suitable for mass production either by die molding and by semiconductor process in comparison with the conventional diffraction element in which the first and the second diffraction gratings 66 and 67 are respectively formed on the entire face of both sides of the diffraction element.

In other words, according to the first embodiment of the present invention, when the diffraction element 6 is produced by die molding, the first and the second diffraction gratings 66 and 67 can be formed with a fixed side die member having excellent transferring property and thus the diffraction element 6 can be formed with a high degree of precision. Further, when die members are assembled, the directions of the stripe on both sides are not required to adjust to each other with a high degree of accuracy as is required in the case of producing the conventional diffraction element.

Alternatively, when the diffraction element 6 is produced by a semiconductor process such as a photo lithography technique, the first and the second diffraction gratings are formed on the same side face of a substrate. Therefore, the productivity is improved in comparison with the case that the diffraction gratings are formed on both sides of the substrate.

In addition, in the diffraction element 6 of the first embodiment, the first diffraction grating formed area 64 and the second diffraction grating formed area 65 are arranged side by side. Therefore, the diffraction element 6 is easily produced and diffracted lights due to dividing the emitting face 63 into two areas are not generated.

Embodiment 2

The diffraction element 6 in the first embodiment is constituted such that the emitting face 63 is divided into two areas of the first diffraction grating formed area 64 and the second diffraction grating formed area 65. However, the emitting face 63 may be divided into a plurality of areas in a stripe shape in which the first diffraction grating formed area 64 and the second diffraction grating formed area 65 are alternately disposed. In this case, the generation of the diffracted lights due to dividing the emitting face 63 into plural areas can be suppressed, for example, by setting the width of one stripe to be about 100 times of the wavelength to perform a satisfactory recording and reproduction.

Embodiment 3

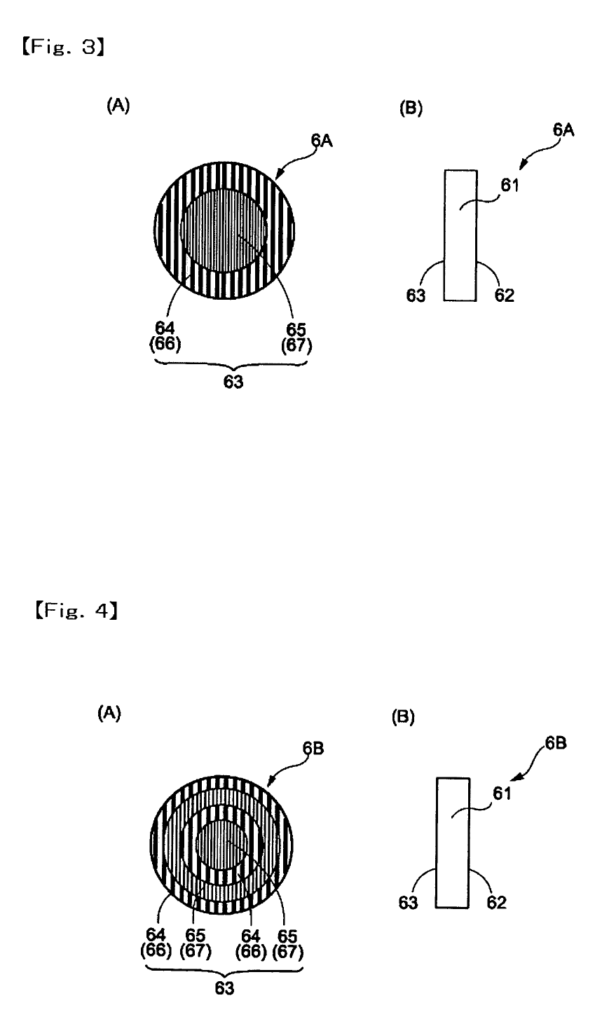

FIG. 3(A) is a plan view of a diffraction element in accordance with a third embodiment of the present invention and FIG. 3(B) is a side view of the diffraction element shown in FIG. 3(A).

As shown in FIGS. 3(A) and 3(B), the diffraction element 6A in the third embodiment of the present invention is formed by a circular translucent substrate 61. One face of the translucent substrate 61 is an incident face 62 for the first and the second laser beams L1 and L2 and the other face is an emitting face 63 therefor.

In the third embodiment, the emitting face 63 is divided into two areas in a concentrically circular shape, one of which is the first diffraction grating formed area 64 on the outer peripheral side, and the other of which is the second diffraction grating formed area 65 on the inner side.

In the first diffraction grating formed area 64, the first diffraction grating 66 is formed, which diffracts the first laser beam L1 at a predetermined first order diffraction efficiency and transmits the second laser beam L2 without diffracting. In the second diffraction grating formed area 65, the second diffraction grating 67 is formed, which transmits the first laser beam L1 without diffracting and diffracts the second laser beam L2 at a predetermined first order diffraction efficiency.

According to the diffraction element 6A described above, a reproducing signal and a recording signal together with a tracking error detection signal can be obtained from the first and the second laser beams L1 and L2 by using the first diffraction grating 66 and the second diffraction grating 67.

Embodiment 4

FIG. 4(A) is a plan view of a diffraction element in accordance with a fourth embodiment of the present invention and FIG. 4(B) is a side view of the diffraction element shown in FIG. 4(A).

As shown in FIGS. 4(A) and 4(B), the diffraction element 6B in the fourth embodiment of the present invention is formed by using a circular translucent substrate 61. One face of the translucent substrate 61 is an incident face 62 for the first and the second laser beams L1 and L2 and the other face is an emitting face 63 therefor.

In the fourth embodiment, the emitting face 63 is divided into two types of plural areas in a concentrically circular shape, one of which is the first diffraction grating formed area 64 and the other of which is the second diffraction grating formed area 65 and they are alternately disposed. For example, in the example shown in FIGS. 4(A) and 4(B), the emitting face 63 is divided into four areas in a concentrically circular shape, in which the first diffraction grating formed area 64 on the outer peripheral side and the second diffraction grating formed area 65 on the inner side are alternately disposed.

In the first diffraction grating formed area 64, the first diffraction grating 66 is formed, which diffracts the first laser beam L1 at a predetermined first order diffraction efficiency and transmits the second laser beam L2 without diffracting. In the second diffraction grating formed area 65, the second diffraction grating 67 is formed, which transmits the first laser beam L1 without diffracting and diffracts the second laser beam L2 at a predetermined first order diffraction efficiency.

According to the diffraction element 6B described above, a reproducing signal and a recording signal together with a tracking error detection signal can be obtained from the first and the second laser beams L1 and L2 by using the first diffraction grating 66 and the second diffraction grating 67. Also, the surface on one side of the translucent substrate 61 is divided into plural areas which are alternately disposed of the first diffraction grating formed area and the second diffraction grating formed area in the radial direction. Therefore, the beam configuration of the diffracted light can be formed to be nearly equal to the incident light and satisfactory recording and reproduction can be performed.

Embodiment 5

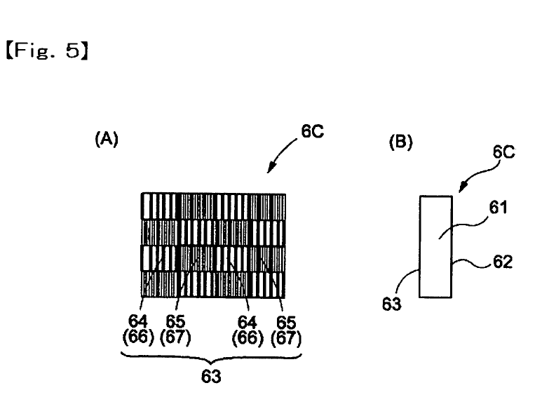

FIG. 5(A) is a plan view of a diffraction element in accordance with a fifth embodiment of the present invention and FIG. 5(B) is a side view of the diffraction element shown in FIG. 5(A).

As shown in FIGS. 5(A) and 5(B), the diffraction element 6C in the fifth embodiment of the present invention is formed by using a rectangular translucent substrate 61. One face of the translucent substrate 61 is an incident face 62 for the first and the second laser beams L1 and L2 and the other face is an emitting face 63 therefor.

In the fifth embodiment, the emitting face 63 is divided into two types of plural areas in a matrix shape, which are composed of the first diffraction grating formed area 64 and the second diffraction grating formed area 65. For example, in the example shown in FIGS. 5(A) and 5(B), the emitting face 63 is divided into two types of plural areas which are composed of the first diffraction grating formed area 64 and the second diffraction grating formed area 65 alternately arranged in vertically four rows and horizontally four lines in a grid shape.

In the first diffraction grating formed area 64, the first diffraction grating 66 is formed, which diffracts the first laser beam L1 at a predetermined first order diffraction efficiency and transmits the second laser beam L2 without diffracting. In the second diffraction grating formed area 65, the second diffraction grating 67 is formed, which transmits the first laser beam L1 without diffracting and diffracts the second laser beam L2 at a predetermined first order diffraction efficiency.

According to the diffraction element 6C described above, a reproducing signal and a recording signal together with a tracking error detection signal can be obtained from the first and the second laser beams L1 and L2 by using the first diffraction grating 66 and the second diffraction grating 67. Also, the emitting face 63 of the translucent substrate 61 is divided into plural areas which are alternately disposed of the first diffraction grating formed area 64 and the second diffraction grating formed area 65 in the grid shape. Therefore, the beam configuration of the diffracted light can be formed to be nearly equal to the incident light and satisfactory recording and reproduction can be performed.

Manufacturing Method 1

The diffraction elements in accordance with the first embodiment through the fifth embodiment of the present invention are manufactured by a semiconductor process such as a film forming technique or a photo lithography technique or by molding with the use of a molding die on which cutting work is performed. When the diffraction element is produced by molding, the step height of the first diffraction grating or the second diffraction grating can be easily changed and thus a high degree of productivity can be attained. Also, the molding with the use of the molding die on which cutting work is performed is capable of lowering the cost of equipment.

For producing the diffraction element by a die molding method, first grooves (steps) for constituting the first diffraction grating and second grooves (steps) for constituting the second diffraction grating are formed on a molding die by cutting work with using a cutting tool. Then, press molding is performed on resin material or glass material by means of the molding die and the diffraction element is formed.

In this case, the first grooves and the second grooves are formed on a fixed side mold member constituting the molding die. When the diffraction element is formed by using the molding die having such a construction, the diffraction element with a high degree of dimensional accuracy can be formed in comparison with the case that the first grooves and the second grooves are formed on a movable side mold member.

Manufacturing Method 2

The diffraction element in accordance with the present invention is produced by molding with the use of the molding die on which cutting work is performed. However, the diffraction element may be produced in such a manner that a translucent material is directly formed with the first grooves (steps) constituting the first diffraction grating and the second grooves (steps) constituting the second diffraction grating by cutting work by using a cutting tool. Even in the second manufacturing method, the step height of the first diffraction grating or the second diffraction grating can be easily changed in comparison with the case that the diffraction grating is formed by a semiconductor process and thus a high degree of productivity can be attained. Also, the cost of equipment is lowered.

Embodiment 6

In the above-mentioned diffraction elements 6, 6A, 6B and 6C, the emitting face 63 is divided into the first diffraction grating formed area 64 and the second diffraction grating formed area 65. Therefore, the first diffraction grating 66 and the second diffraction grating 67 are partially formed on the emitting face 63. However, alternatively, one of the incident face 62 and the emitting face 63 is partially formed with the first diffraction grating 66 and the other is partially formed with the second diffraction grating 67. In other words, both the incident face 62 and the emitting face 63 may be partially provided with either the first diffraction grating 66 or the second diffraction grating 67.

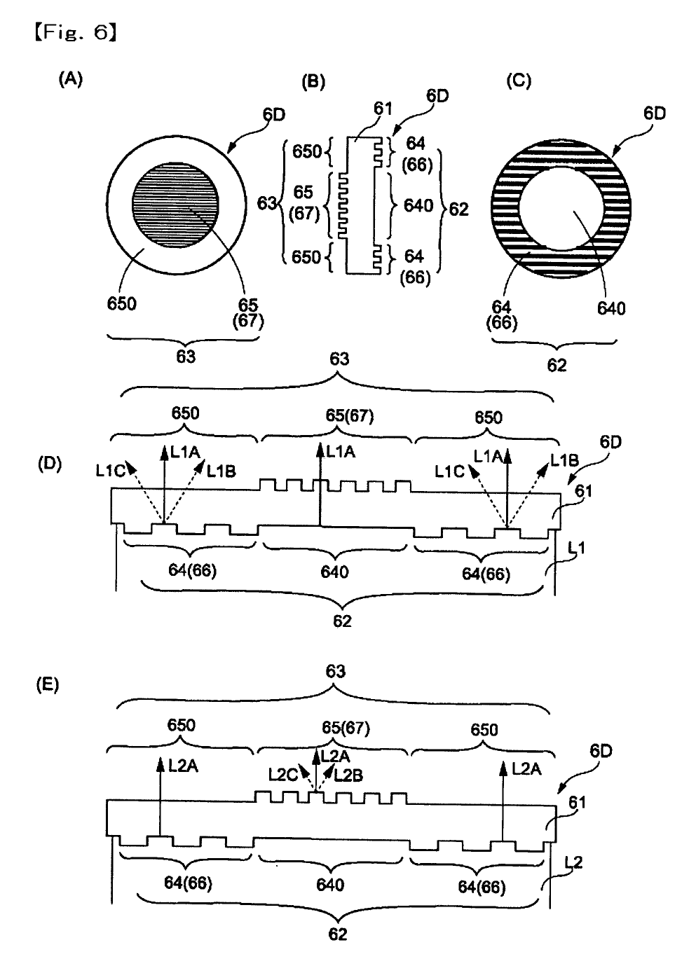

FIG. 6(A) is a plan view of a diffraction element in accordance with a seventh embodiment of the present invention, FIG. 6(B) is its side view, FIG. 6(C) is its rear face view, FIG. 6(D) is an explanatory view showing diffracting state of the first laser beam L1 by the diffraction element, and FIG. 6(E) is an explanatory view showing diffracting state of the second laser beam L2 by the diffraction element.

As shown in these drawings, the diffraction element 6D in the seventh embodiment is formed of a circular translucent substrate 61. The translucent substrate 61 is provided with an incident face 62 for the first laser beam L1 and the second laser beam L2 on one side and an emitting face 63 on the other side.

In the seventh embodiment, the first diffraction grating 66 is partially formed on the incident face 62 and the second diffraction grating 67 is partially formed on the emitting face 63.

The incident face 62 is divided into two areas in a concentrically circular shape, which are composed of the first diffraction grating formed area 64 on the outer peripheral side and an inner side area 640 surrounded by the first diffraction grating formed area 64.

In the first diffraction grating formed area 64, the first diffraction grating 66 is formed which diffracts the first laser beam L1 at a predetermined first order diffraction efficiency and transmits the second laser beam L2 without diffracting. The inner side area 640 is a flat face which is not formed with the first diffraction grating 66 and thus transmits the first laser beam L1 and the second laser beam L2 without diffracting. Therefore, the first diffraction grating formed area 64 is the transmission area of the second laser beam L2 where the second laser beam L2 is transmitted without diffracting, i.e., the zero-order light area of the second laser beam L2. The inner side area 640 is the transmission area of the first laser beam L1 where the first laser beam L1 is transmitted without diffracting, i.e., the zero-order light area of the first laser beam L1.

The emitting face 63 is divided into two areas in a concentrically circular shape which are composed of the second diffraction grating formed area 65 on the inner side and an outer peripheral side area 650 surrounding the first diffraction grating formed area 64.

In the second diffraction grating formed area 65, the second diffraction grating 65 is formed which diffracts the second laser beam L2 at a predetermined first order diffraction efficiency and transmits the first laser beam L1 without diffracting. The outer peripheral side area 650 is a flat face which is not formed with the second diffraction grating 65 and thus transmits the first laser beam L1 and the second laser beam L2 without diffracting. Therefore, the second diffraction grating formed area 65 is the transmission area of the first laser beam L1 where the first laser beam L1 is transmitted without diffracting, i.e., the zero-order light area of the first laser beam L1. The outer peripheral side area 650 is the transmission area of the second laser beam L2 where the second laser beam L2 is transmitted without diffracting, i.e., the zero-order light area of the second laser beam L2.

In the optical head device 1 shown in FIG. 1 provided with the diffraction element 6D constituted as described above, when reproduction or recording for a DVD-R as the optical recording medium 5 is performed, the first laser beam L1 is incident on the entire incident face 62 of the diffraction element 6D as shown in FIG. 6(D). The diffraction element 6D diffracts the first laser beam L1 which passes through the first diffraction grating 66 of the incident face 62 into the zero-order light L1A and ±first-order diffracted lights L1B and L1C and emits from the outer peripheral side area 650 of the emitting face 63. Therefore, the size of the first diffraction grating 66 of the incident face 62 is substantially equal to the size of the outer peripheral side area 650 of the emitting face 63. The tracking error detection at the time of reproducing or recording for the DVD-R is performed by the ±first-order diffracted lights L1B and L1C. The first laser beam L1 which passes through the inner side area 640 of the incident face 62 is emitted in the state of zero-order light L1A from the second diffraction grating 67 of the emitting face 63 without diffracted. Therefore, the ratio of the zero-order light L1A for the DVD-R can be increased with respect to the ±first-order diffracted lights L1B and L1C. The reproducing or recording for the DVD-R is performed by the zero-order light L1A passed through the second diffraction grating 67 and the zero-order light L1A emitted from the first diffraction grating 66.

On the other hand, when reproduction or recording for a CD-R as the optical recording medium 5 is performed, the second laser beam L2 is incident on the entire incident face 62 of the diffraction element 6D as shown in FIG. 6(E). The diffraction element 6D diffracts the second laser beam L2 which passes through the inner side area 640 of the incident face 62 into the zero-order light L2A and ±first-order diffracted lights L2B and L2C by the second diffraction grating 65 of the emitting face 63. Therefore, the size of the inner side area 640 of the incident face 62 is substantially equal to the size of the second diffraction grating 65 of the emitting face 63. The tracking error detection at the time of reproducing or recording for the CD-R is performed by the ±first-order diffracted lights L2B and L2C. The second laser beam L2 which passes through the first diffraction grating 66 of the incident face 62 is emitted in the state of zero-order light L2A without diffracting from the outer peripheral side area 650 of the emitting face 63. The reproducing or recording for the CD-R is performed by the zero-order light L2A passing through the first diffraction grating 66 and the zero-order light L2A emitted from the second diffraction grating 67.

According to the diffraction element 6D described above, a reproducing signal and a recording signal together with a tracking error detection signal can be obtained from the first and the second laser beams L1 and L2 by using the first diffraction grating 66 and the second diffraction grating 67 which are partially formed either on the incident face 62 or the emitting face 63.

In addition, the demultiplexing ratio of the zero-order light to the first-order diffracted light of the laser beam can be easily adjusted by means of adjusting the area of the first diffraction grating formed area 64 and the area of the second diffraction grating formed area 65. Accordingly, the zero-order light necessary for recording can be obtained with a high degree of power. Moreover, the diffraction element 6D can be used for a twin laser light source which carries both the first and the second laser light sources 2 and 3 within the same package.

Besides, the diffraction element 6D can be disposed on the common optical path away from the first and the second laser light sources 2 and 3. Therefore, the pitch of the grating in the first and the second diffraction gratings 66 and 67 can be widened. Accordingly, the first and the second diffraction gratings 66 and 67 can be formed easily in mass production.

In addition, the first and the second diffraction gratings 66 and 67 are respectively formed on either side of the diffraction element 6D. Therefore, it is difficult to produce the diffraction grating by a semiconductor process. However, when the diffraction grating is produced by cutting work by using a cutting tool on a molding die or a translucent material directly, the first and the second diffraction gratings 66 and 67 are respectively formed on both sides of the diffraction element 6 in a partial area. Therefore, the diffraction element 6D in the seventh embodiment is suitable for a mass production in comparison with the case that the first and the second diffraction gratings 66 and 67 are formed on the entire surface area of both sides of the diffraction element.

In other words, since the first and the second diffraction gratings 66 and 67 are respectively formed in a partial area, even when a movable side die member having a poor transferring property forms one of the first and the second diffraction gratings 66 and 67, the diffraction grating can be accurately formed in comparison with the case that the diffraction grating is formed on the entire surface area of the diffraction element. Also, at the time of assembling the molding die members, the directions of the stripes of the diffraction gratings can be aligned with a high degree of accuracy in comparison with the case that the diffraction gratings are respectively formed on the entire surface area of both sides of the diffraction element.

When the diffraction element is produced by cutting work by using a cutting tool directly to a translucent material, the step height of the first diffraction grating 66 or the second diffraction grating 67 can be easily changed and thus a high degree of productivity can be attained.

According to the diffraction element 6D in the seventh embodiment, the first diffraction grating formed area 64 and the second diffraction grating formed area 65 are disposed in a concentrically circular shape. Therefore, the beam configuration of the first laser beam and the second laser beam can be formed to be nearly equal to the incident light and satisfactory recording and reproduction can be performed.

In addition, when the first diffraction grating 66, i.e., the first diffraction grating formed area 64 is arranged so as to surround the inner side area 640 which is formed with a flat surface of the translucent substrate 61, the beam configuration of the zero-order beam can be sharply formed.

Furthermore, the forming area of the first diffraction grating 66 (first diffraction grating formed area 64) disposed on the outer peripheral side is preferably formed wider than the effective diameters of the first and the second laser beams. According to the construction described above, in the case of the adjustment when the diffraction element 6D is mounted on the optical head device 1, the range of positional adjustment for the diffraction element 6D is widened with respect to the positional adjustment along the optical axis, the direction orthogonal to the optical axis, and the rotational adjustment in which the diffraction element 6D is rotated around the optical axis to adjust the direction of the diffraction grating. Therefore, the rotational adjustment of the diffraction element 6D is easily performed.

Disposing Example of Diffraction Element in Optical Head Device

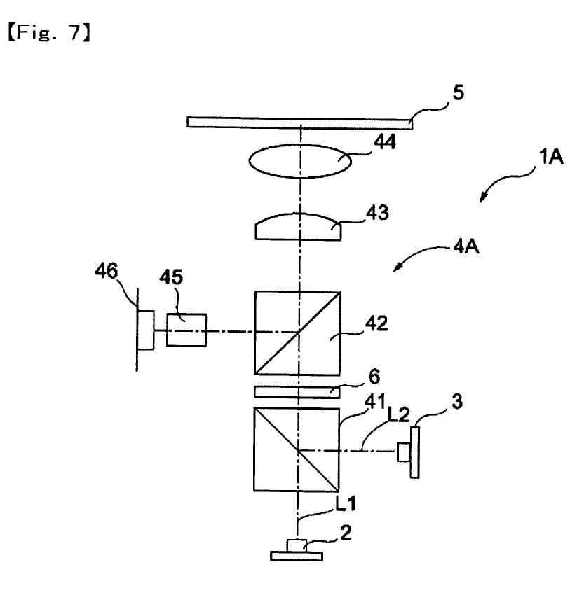

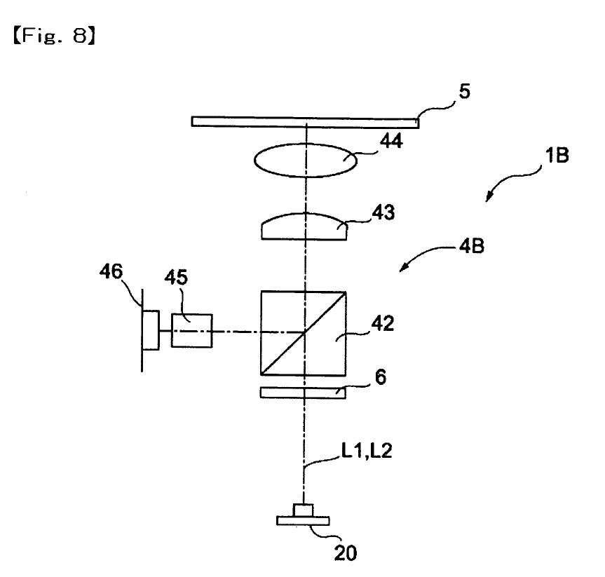

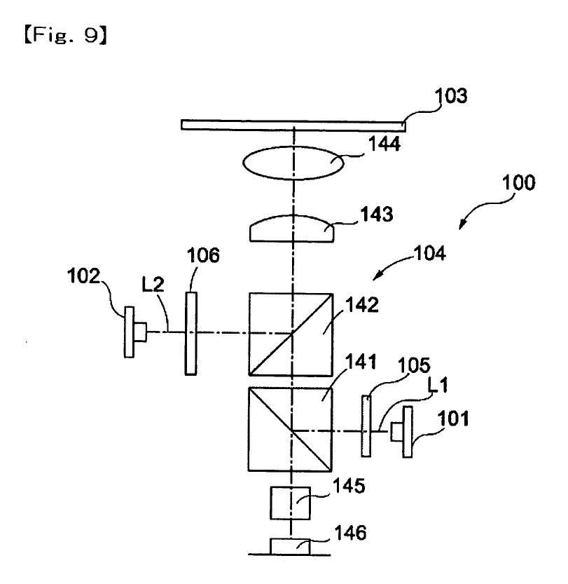

FIG. 7 is an explanatory view showing another disposing position of the diffraction element in an optical head device accordance with an embodiment of the present invention. FIG. 8 is an explanatory view showing a disposing position of the diffraction element in an optical head device provided with a twin laser which emits a first laser beam and a second laser beam.

In the above-mentioned optical head device 1, the diffraction element 6 is disposed between the second beam splitter 42 and the collimating lens 43 in the common optical system 4. In this embodiment of the present invention, the position of the diffraction element 6 is the position where the first and the second laser beams L1 and L2 toward the optical recording medium 5 pass through and the return beams reflected by the optical recording medium 5 of the first and the second laser beams L1 and L2 also pass through. Accordingly, a noise may be generated by the diffraction of the return beam in the diffraction element 6, which may affect the recording and reproduction for the optical recording medium 5. In order to prevent such a noise, the diffraction element 6 is preferably disposed at a position where only the first and the second laser beams L1 and L2 toward the optical recording medium 5 pass but the return beams reflected by the optical recording medium 5 do not pass through.

As shown in FIG. 7, an optical head device 1A includes a first laser diode 2 emitting the first laser beam L1 for reproducing and recording a DVD-R, a second laser diode 3 emitting the second laser beam for reproducing and recording a CD-R, and a common optical system 4A.

The common optical system 4A includes a first beam splitter 41 which transmits the first laser beam L1 toward the optical recording medium 5 and reflects the second laser beam L2 toward the optical recording medium 5, a second beam splitter 42 which transmits the first laser beam L1 or the second laser beam L2 from the first beam splitter 41, a collimating lens 43 for converting the first laser beam L1 or the second laser beam L2 from the second beam splitter 42 into a parallel light, and an objective lens 44 for condensing the parallel light from the collimating lens 43 to the optical recording medium 5.

The common optical system 4 also includes a sensor lens 45 for condensing the return light of the first or the second laser beam which is reflected by the optical recording medium 5 and reflected by the second beam splitter 42, and a light receiving element 46 which receives the return light of the first laser beam L1 or the second laser beam L2 which passes through the sensor lens 45.

In this embodiment, the common optical system 4A is provided with the diffraction element 6, which emits the zero-order beam and the ±first order diffracted lights of the first laser beam L1 or the second laser beam L2, between the first beam splitter 41 and the second beam splitter 42.

According to the optical head device 1A having a construction described above, only the first and the second laser beams L1 and L2 toward the optical recording medium 5 pass through the diffraction element 6 and the return beams reflected by the optical recording medium 5 do not pass through the diffraction element 6. Therefore, the generation of a noise due to the diffraction of the return beams is prevented, and thus reproducing from and recording into the optical recording medium 5 can be satisfactorily performed.

An optical head device 1B shown in FIG. 8 includes a twin laser 20, which emits the first laser beam L1 and the second laser beam L2 with one semiconductor device instead of the first and the second laser diodes 2 and 3, and a common optical system 4B. The common optical system 4B also includes a beam splitter 42, which transmits the first laser beam or the second laser beam toward the optical recording medium and reflects the return beam from the optical recording medium 5 toward the light receiving element 46, the collimating lens 43, the sensor lens 45, the light receiving element 46 and the diffraction element 6.

In the common optical system 4B, the diffraction element 6 is disposed between the twin laser 20 and the beam splitter 42, and thus only the first and the second laser beams L1 and L2 toward the optical recording medium 5 pass through but the return beam reflected by the optical recording medium 5 does not pass through the diffraction element 6.

According also to the optical head device 1B having a construction described above, the return beams reflected by the optical recording medium 5 do not pass through the diffraction element 6. Therefore, the generation of a noise due to the diffraction of the return beams is prevented, and thus reproducing from and recording into the optical recording medium 5 can be satisfactorily performed.

Other Embodiments

The optical head devices 1, 1A and 1B are applicable to a plurality of types of optical recording media 5 in which the substrate thicknesses and recording densities are different to one another. In other words, the optical head device is applicable not only to a combination of a DVD-R and a CD-R but also to a combination of a DVD-R and a BRD (Blu-rayDisc) of which its recording density is higher and its substrate thickness protecting a recording surface is thinner than that of DVD-R, or a combination of the BRD and the CD-R for performing recording or reproducing.

When the diffraction element is used in an optical head device for performing recording into and reproducing from three types of optical recording media of which their substrate thicknesses and recording densities are different to one another by using three different laser beams whose wavelengths are respectively different to one another, one of the first diffraction grating 66 and the second diffraction grating 67 in the diffraction element 6D shown in FIG. 6 is further divided into two areas to constitute the diffraction element provided with three types of diffraction gratings.

In this case, the diffraction element is constituted of a translucent substrate in which one face of the translucent substrate is divided into at least a first diffraction grating formed area, where the first diffraction grating which diffracts the first laser beam with a predetermined diffraction efficiency is formed, and an area which does not diffract the second laser beam and the third laser beam. The other face of the translucent substrate opposite to the one face of the translucent substrate is divided into a second diffraction grating formed area where the second diffraction grating which diffracts the second laser beam with a predetermined diffraction efficiency and transmits the third laser beam without diffracting is formed, a third diffraction grating formed area where the third diffraction grating which diffracts the third laser beam with a predetermined diffraction efficiency and transmits the second laser beam without diffracting is formed, and an area which does not diffract the first laser beam.

The second diffraction grating formed area and the third diffraction grating formed area on the other face of the above-mentioned diffraction element may be divided in a stripe shape, two areas in a concentrically circular shape, plural areas in a concentrically circular shape, or in a matrix shape as shown in FIGS. 2 through 4.

According to the diffraction element constituted described above, the zero-order light and the first diffracted lights of the first laser beam are obtained by the first diffraction grating formed on one of the incident face and the emitting face of the diffraction element. Also, the second diffraction grating and the third diffraction grating are formed on the other face of the incident face and the emitting face and thus the zero-order light and the first diffracted lights of the second laser beam are obtained by the second diffraction grating and the zero-order light and the first diffracted lights of the third laser beam are obtained by the third diffraction grating. Therefore, the demultiplexing ratio of the zero-order light and the first order diffracted lights of the respective diffraction gratings can be easily adjusted based on the areas of the respective diffraction grating formed areas.

As described above, in the diffraction element to which the present invention is applied or in the optical head device with the use of the diffraction element, the first diffraction grating is formed in a partial area on the incident face or the emitting face of the diffraction element such that the first laser beam is diffracted and the second laser beam is transmitted without being diffracted, and the second diffraction grating is also formed in a partial area on the incident face or the emitting face of the diffraction element such that the second laser beam is diffracted and the first laser beam is transmitted. Accordingly, only one diffraction element can provide the zero-order light and the diffracted lights of each of the first laser beam and the second laser beam to generate the reproducing signal, recording signal and tracking error detection signal for two types of optical recording media.

Also, in a conventional diffraction grating, the demultiplexing ratio of the zero-order light and the first order diffracted lights is adjusted from the step height and the duty ratio of the diffraction grating. However, in the diffraction element according to the present invention, the demultiplexing ratio of the zero-order light and the first order diffracted lights is also capable of being easily adjusted by adjusting the areas of the first diffraction grating formed area and the second diffraction grating formed area. Therefore, the degree of freedom of a design is remarkably widened and thus the optimal diffraction element with a high degree of efficiency is obtained with respect to the first and the second laser beams. In addition, the diffraction element according to the present invention can be applied to the twin laser in which the first and the second laser light sources are mounted within one package.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical head device comprising:
a first light source which emits a first laser beam;
a second light source which emits a second laser beam with a wavelength different from a wavelength of the first laser beam;
a common optical path for guiding the first laser beam or the second laser beam emitted from the first light source or the second light source respectively to an optical recording medium; and
a diffraction element disposed on the common optical path, the diffraction element comprising:
a first diffraction grating formed in a partial area on an incident face or an emitting face of the diffraction element such that the first laser beam is diffracted and the second laser beam is transmitted without being diffracted; and
a second diffraction grating formed in a partial area on the incident face or the emitting face of the diffraction element such that the second laser beam is diffracted and the first laser beam is transmitted.

2. The optical head device according to claim 1, wherein the diffraction element includes a translucent substrate on which a first diffraction grating formed area where the first diffraction grating is formed and a second diffraction grating formed area where the second diffraction grating is formed are dividedly provided on a same side face of the translucent substrate.

3. The optical head device according to claim 2, wherein the first diffraction grating formed area and the second diffraction grating formed area are formed so as to be divided in a stripe shape.

4. The optical head device according to claim 2, wherein the first diffraction grating formed area and the second diffraction grating formed area are formed so as to be divided in a concentrically circular shape.

5. The optical head device according to claim 4, wherein each of the first diffraction grating formed area and the second diffraction grating formed area are divided into plural areas and the first diffraction grating formed area and the second diffraction grating formed area are positioned alternately.

6. The optical head device according to claim 2, wherein the first diffraction grating formed area and the second diffraction grating formed area are formed so as to be divided in a matrix shape.

7. The optical head device according to claim 1, wherein the diffraction element is formed of a translucent substrate having a first face which is divided into a first diffraction grating formed area where the first diffraction grating is formed and a transmitting area where the first laser beam is not diffracted and having a second face which is divided into a second diffraction grating formed area where the second diffraction grating is formed and a transmitting area where the second laser beam is not diffracted, and the first face and the second face are opposite to each other.

8. The optical head device according to claim 7, wherein the first diffraction grating formed area and the second diffraction grating formed area are formed in a concentrically circular shape.

9. The optical head device according to claim 8, wherein the first diffraction grating formed area is wider than an effective diameter of the first laser beam passing through the first diffraction grating formed area and the second diffraction grating formed area is wider than an effective diameter of the second laser beam passing through the second diffraction grating formed area.

10. The optical head device according to claim 1, wherein the first diffraction grating and the second diffraction grating are respectively formed of a plurality of steps with a predetermined height.

11. The optical head device according to claim 10, wherein a step height of the first diffraction grating is set to satisfy an equation “aλ2/(n−1)” and a step of the second diffraction grating is set to satisfy an expression “bλ1/(n−1), wherein “λ1” is a wavelength of the first laser beam, “λ2” is a wavelength of the second laser beam, “n” is a refractive index of the translucent substrate, and “a” and “b” are respectively an integer number not less than “1”

12. The optical head device according to claim 1, wherein an optical component of the first laser beam diffracted by the first diffraction grating is set to be in phase with an optical component of the first laser beam transmitted through the second diffraction grating.

13. The optical head device according to claim 1, wherein a wavelength of the first laser beam is shorter than a wavelength of the second laser beam, and the diffraction element is provided with an area which does not diffract the first laser beam at a center portion including an optical axis.

14. The optical head device according to claim 1, wherein the diffraction element is disposed on the common optical path at a position where the first laser beam and the second laser beam toward the optical recording medium pass through and return lights of the first laser beam and the second laser beam reflected by the optical recording medium do not pass through.

15. A diffraction element in which a first laser beam and a second laser beam having a wavelength different from a wavelength of the first laser beam are capable of being incident, comprising:
a translucent substrate constituting the diffraction element;
a first diffraction grating formed area which is formed in a partial area on one face of the translucent substrate in such a manner that the first diffraction grating which diffracts the first laser beam and transmits the second laser beam without diffracting is formed; and
a second diffraction grating formed area which is formed in a partial area on the one face of the translucent substrate in such a manner that the second diffraction grating which diffracts the second laser beam and transmits the first laser beam without diffracting is formed.

16. A diffraction element in which a first laser beam and a second laser beam having a wavelength different from a wavelength of the first laser beam are capable of being incident, comprising:
a translucent substrate constituting the diffraction element;
one face of the translucent substrate divided into a first diffraction grating formed area where the first diffraction grating which diffracts the first laser beam and transmits the second laser beam without diffracting is formed and an area which does not diffract the first laser beam; and
the other face of the translucent substrate opposite to the one face of the translucent substrate divided into a second diffraction grating formed area where the second diffraction grating which diffracts the second laser beam and transmits the first laser beam without diffracting is formed and an area which does not diffract the second laser beam.

17. A diffraction element in which a first laser beam, a second laser beam and a third laser beam respectively having different wavelengths from one another are capable of being incident, comprising:
a translucent substrate constituting the diffraction element;
one face of the translucent substrate divided into a first diffraction grating formed area where the first diffraction grating which diffracts the first laser beam with a predetermined diffraction efficiency is formed and an area which does not diffract the second laser beam and the third laser beam; and
the other face of the translucent substrate opposite to the one face of the translucent substrate divided into a second diffraction grating formed area where the second diffraction grating which diffracts the second laser beam with a predetermined diffraction efficiency and transmits the third laser beam without diffracting is formed, a third diffraction grating formed area where the third diffraction grating which diffracts the third laser beam with a predetermined diffraction efficiency and transmits the second laser beam without diffracting is formed, and an area which does not diffract the first laser beam.

18. A manufacturing method for a diffraction element in which a first laser beam and a second laser beam having a wavelength different from a wavelength of the first laser beam are capable of being incident, comprising:
providing a molding die for molding the diffraction element;
forming first grooves, which are used to form a first diffraction grating in a partial area on an incident face or an emitting face of the diffraction element such that the first laser beam is diffracted and the second laser beam is transmitted without being diffracted, on the molding die by cutting work;
forming second grooves, which are used to form a second diffraction grating in a partial area on the incident face or the emitting face of the diffraction element such that the second laser beam is diffracted and the first laser beam is transmitted without being diffracted, on the molding die by cutting work; and then
molding the diffraction element by using the molding die.

19. The manufacturing method for a diffraction element according to claim 18, wherein the first grooves and the second grooves are respectively formed on a fixed side mold member of the molding die.

20. A manufacturing method for a diffraction element in which a first laser beam and a second laser beam having a wavelength different from a wavelength of the first laser beam are capable of being incident, comprising:
providing a translucent substrate for constituting the diffraction element;
forming first grooves on the translucent substrate by cutting work for a first diffraction grating in a partial area such that the first laser beam is diffracted and the second laser beam is transmitted without being diffracted; and
forming second grooves on the translucent substrate by cutting work for a second diffraction grating in a partial area such that the second laser beam is diffracted and the first laser beam is transmitted without being diffracted.

21. A manufacturing method for a diffraction element in which a first laser beam and a second laser beam having a wavelength different from a wavelength of the first laser beam are capable of being incident, comprising:
providing a molding die for molding the diffraction element;
forming first grooves, which are used to form a first diffraction grating formed area on one face of the diffraction element partially such that the first laser beam is diffracted and the second laser beam is transmitted without being diffracted, on the molding die by cutting work in such a manner that the one face of the diffraction element is divided into the first diffraction grating formed area and an area where the first laser beam is not diffracted;
forming second grooves, which are used to form a second diffraction grating formed area on the other face of the diffraction element partially such that the second laser beam is diffracted and the first laser beam is transmitted without being diffracted, on the molding die by cutting work in such a manner that the other face of the diffraction element is divided into the second diffraction grating formed area and an area where the second laser beam is not diffracted; and then
molding the diffraction element by using the molding die.

22. A manufacturing method for a diffraction element in which a first laser beam and a second laser beam having a wavelength different from a wavelength of the first laser beam are capable of being incident, comprising:
providing a translucent substrate for constituting the diffraction element;
forming first grooves for a first diffraction grating formed area on one face of the translucent substrate partially such that the first laser beam is diffracted and the second laser beam is transmitted without being diffracted by cutting work in such a manner that the one face of the translucent substrate is divided into the first diffraction grating formed area and an area where the first laser beam is not diffracted; and
forming second grooves for a second diffraction grating formed area on the other face of the translucent substrate partially such that the second laser beam is diffracted and the first laser beam is transmitted without being diffracted by cutting work in such a manner that the other face of the diffraction element is divided into the second diffraction grating formed area and an area where the second laser beam is not diffracted.
